(19) United States
(12) Patent Application Publication
(10) Pub. No.: US 2011/0203005 A1
(43) Pub. Date: Aug. 18, 2011

(54) SOFTWARE DISTRIBUTION METHOD, INFORMATION PROCESSING APPARATUS, AND SOFTWARE DISTRIBUTION SYSTEM

(75) Inventor: Ryo Hamada, Osaka-Shi (JP)

(73) Assignee: SHARP KABUSHIKI KAISHA, Osaka (JP)

(21) Appl. No.: 13/029,937

(22) Filed: Feb. 17, 2011

(30) Foreign Application Priority Data
Feb. 17, 2010 (JP) 2010-032723

(51) Int. Cl. G06F 21/22

(52) U.S. Cl. 726/28

(57) ABSTRACT

A distribution server acquires authentication information acquired from an IC card reader of an MFP and authenticated by an authentication server, and generates an installer for software which allows addition of the authentication information to transmission data of a client PC and transmission of the transmission data such that the acquired authentication information and an installer for a device driver of an image formation section of the MFP are included in the installer. Subsequently, the distribution server distributes the generated installer to a user to be authenticated using the authentication information.

### CROSS-REFERENCE TO RELATED APPLICATIONS

This Nonprovisional application claims priority under 35 U.S.C. §119(a) on Patent Application No. 2010-32723 filed in Japan on Feb. 17, 2010, the entire contents of which are hereby incorporated by reference.

### BACKGROUND

1. Technical Field

The present invention relates to a software distribution method, an information processing apparatus, and a software distribution system including the information processing apparatus which distribute installation software for installing software which allows addition of authentication information to transmission data and transmission of the transmission data.

2. Description of Related Art

Conventionally, when a print request of a user is made from an information processing apparatus such as a personal computer (hereinafter referred to as a PC) connected to a printer apparatus or the like, the printer apparatus performs processing in which authentication of the user is performed, the print request of an unauthenticated user is canceled, and the number of paper sheets that are print-outputted on the basis of the print request of an authenticated client is counted for each client. In addition, when a print request of a user which selects one of a plurality of printer apparatuses is made from a plurality of information processing apparatuses present in an office, the print request is temporarily stored in a print server, and a printer apparatus having received the print request from the print server performs authentication of the user and print output, whereby the user is capable of causing an arbitrary printing apparatus to perform the print output.

For example, Japanese Patent Application Laid-Open No. 11-95938 discloses a print system in which a center-side data processing apparatus (print server) assigns an ID code to a data file and a data code for identifying the data file which are transmitted from a user-side data processing apparatus (information processing apparatus) and transmits the ID code to the user-side data processing apparatus, and, when a data code and an ID code which are inputted from a printer and the data code and the ID code which are transmitted from the user-side data processing apparatus to the printer match with each other, the printer performs printing on the basis of the data file transmitted from the center-side data processing apparatus.

As described above, in order to improve security using the authentication and execute the counting of the number of paper sheets that are print-outputted for each user without error, a print request which does not include proper authentication information of some sort is normally cancelled by the printer apparatus or the print server. Consequently, it is necessary to preset the authentication information in software which transmits the print request to the printer apparatus and the print server. However, when the setting is erroneously performed, the print request is cancelled. Accordingly, the setting of the authentication information which is highly dependent on a manual operation tends to be an impediment to the facilitation of installation of software for printing.

In contrast to this, Japanese Patent Application Laid-open No. 2002-169673 discloses an image formation apparatus management system in which, in a case where a DB server receives a request for acquiring a printer driver of an image formation apparatus from a terminal apparatus, the DB server transmits the printer driver to which identification information of the image formation apparatus is added to the terminal apparatus when identification information unique to a user of the terminal apparatus and identification information of the user pre-stored in the DB server match with each other. Since the printer driver transmitted to the terminal apparatus is installed in the terminal apparatus with the unique identification information inputted from the terminal apparatus by the user included in the printer driver, the identification information of the user and the identification information of the image formation apparatus are added to print data transmitted to the DB server by the terminal apparatus.

### SUMMARY OF THE INVENTION

However, in the technology disclosed in Japanese Patent Application Laid-Open No. 2002-169673, since it is not possible to separate the installation of the printer driver which the user causes the information processing apparatus to execute from the authentication of the user which is executed by the DB server on the identification information unique to the user inputted from the terminal apparatus, there has been a problem that it is not possible to adopt a configuration in which a printer driver including authentication information of the user, or installation software (hereinafter simply referred to as an installer) for installing the printer driver is distributed.

The present invention has been achieved in view of the above-described circumstances, and an object thereof is to provide a software distribution method, an information processing apparatus, and a software distribution system including the information processing apparatus which are capable of distributing an installer for software to a user with authentication information of the user or information generated on the basis of the authentication information included in the installer for software.

The software distribution method according to the present invention is a software distribution method for generating, using an information processing apparatus, installation software for installing software which allows addition of authentication information to transmission data and transmission of the transmission data in another information processing apparatus, and distributing the installation software to a user to be authenticated using the authentication information, including steps of acquiring the authentication information, and generating the installation software in which the acquired authentication information or information generated on the basis of the authentication information, and predetermined software are included.

In the software distribution method according to the present invention, the predetermined software is an installer for a device driver of an image formation apparatus which is to form an image on the basis of image data transmitted by the another information processing apparatus.

The installation method according to the present invention is an installation method for installing software which allows addition of authentication information to transmission data and transmission of the transmission data in an information processing apparatus by using installation software in which the authentication information or information generated on the basis of the authentication information, and predetermined software are included, including steps of causing the information processing apparatus to execute the predetermined software included in the installation software to install the software which allows the transmission of the transmission data to which the authentication information is to be added, extracting the authentication information from the information included in the installation software, and performing a setting of the installed software such that the extracted authentication information is added to the transmission data.

In the installation method according to the present invention, the predetermined software is an installer for a device driver of an image formation apparatus which is to form an image on the basis of image data transmitted by the information processing apparatus.

The information processing apparatus according to the present invention is an information processing apparatus which generates installation software for installing software which allows addition of authentication information to transmission data and transmission of the transmission data in another information processing apparatus using generating means, and distributes the installation software to an apparatus associated with a user to be authenticated using the authentication information, including acquiring means for acquiring the authentication information, wherein the generating means generates the installation software in which the authentication information acquired by the acquisition means or information generated on the basis of the authentication information, and predetermined software are included.

In the information processing apparatus according to the present invention, the predetermined software is an installer for a device driver of an image formation apparatus which is to form an image on the basis of image data transmitted by the another information processing apparatus.

The software distribution system according to the present invention includes the information processing apparatus receiving and acquiring authentication information, an authentication apparatus receiving and authenticating the authentication information, and transmitting an authentication result to a transmission source of the authentication information, and an acquisition apparatus acquiring the authentication information and transmitting the authentication information to the authentication apparatus, and receiving the authentication result and transmitting the authenticated authentication information to the information processing apparatus.

In the software distribution system according to the present invention, the authentication apparatus includes storage means for storing an attribute of a user to be authenticated using the authentication information, and means for extracting, when the authentication information acquired by the acquisition apparatus is authenticated, the attribute of the authenticated user from the attribute stored in the storage means, and causes the attribute of the user extracted by the means to be included in the authentication result, the acquisition apparatus transmits the attribute of the user included in the received authentication result to the information processing apparatus, the information processing apparatus includes a second acquiring means for acquiring an attribute of the user, and the generating means generates installation software in which information in correspondence to the attribute of the user acquired by the second acquiring means is further included.

In the software distribution system according to the present invention, the information processing apparatus is caused to serve also as the authentication apparatus.

In the software distribution system according to the present invention, the acquisition apparatus is an image processing apparatus performing image processing on an image on the basis of image data transmitted by the another information processing apparatus, and the image processing apparatus includes means for acquiring the authentication information.

In the present invention, the authentication information is acquired, the installer for the software which allows addition of the authentication information to the transmission data of another information processing apparatus and transmission of the transmission data is generated so as to include the acquired authentication information or the information generated on the basis of the authentication information, and the predetermined software, and the generated installer is distributed to the user to be authenticated using the authentication information.

With this arrangement, in a case where the authentication information of the user to which the generated installer is to be distributed is authenticated and acquired by the information processing apparatus, the installer is distributed from the information processing apparatus to the user with the authentication information of the authenticated user or the information generated on the basis of the authentication information included in the installer. In addition, in a case where the authentication information is restored from the information included in the installer when the distributed installer is executed in another information processing apparatus, the authentication information of the authenticated user is added to the transmission data of another information processing apparatus. Further, in a case where the authentication information of the user is acquired from an IC card, since the display or key input of the authentication information is not required, steal of the authentication information is prevented.

Consequently, it becomes possible to distribute the installer for the software to the user with the authentication information of the user or the information generated on the basis of the authentication information included in the installer for the software so that the installation of the software is facilitated.

In the present invention, the installer for the device driver of the image formation apparatus which is to form the image on the basis of the image data from another information processing apparatus, and the authentication information acquired by the information processing apparatus or the information generated on the basis of the authentication information are included in the installer to be distributed.

With this arrangement, in a case where the installer distributed to the user is executed in another information processing apparatus, the device driver of the image formation apparatus is installed together with the authentication information, and the authentication information of the user is added to the image data transmitted to the image formation apparatus by another information processing apparatus.

In the present invention, the information processing apparatus acquires the authentication information acquired by the acquisition apparatus and authenticated by the authentication apparatus, generates the installer for the software which allows addition of the authentication information to the transmission data of another information processing apparatus and transmission of the transmission data, and distributes the generated installer to the user to be authenticated using the authentication information.

With this arrangement, in a case where the authentication information of the user to which the generated installer is to be distributed is acquired by the acquisition apparatus and authenticated by the authentication apparatus, the generated installer is distributed from the information processing apparatus to the authenticated user.

In the present invention, in a case where the authentication apparatus authenticates the acquired authentication information, the authentication apparatus extracts the attribute of the authenticated user from the attributes stored in the storage means and causes the attribute of the user to be included in the authentication result, and the acquisition apparatus acquires the authentication result including the attribute of the user from the authentication apparatus. Subsequently, the information processing apparatus generates the installation software (installer) in which the information in correspondence to the attribute of the user acquired from the acquisition apparatus is further included together with the authentication information.

With this arrangement, the generated installer is distributed from the information processing apparatus to the authenticated user with the information in correspondence to the attribute of the authenticated user included in the generated installer. In addition, in a case where a function in correspondence to the information is set when the distributed installer is executed in another information processing apparatus, the use of the function in another information processing apparatus is permitted or prohibited in accordance with the attribute of the authenticated user.

In the present invention, since the information processing apparatus also plays the role of the authentication apparatus, it is possible to compactly configure the system.

In the present invention, the image processing apparatus which performs the image processing on the image on the basis of the image data from another information processing apparatus has the means for acquiring the authentication information, and also plays the role of the acquisition apparatus which acquires the authentication information of the user.

With this arrangement, it is possible to acquire the authentication information of the user to which the installer is to be distributed by the image processing apparatus which causes the authentication apparatus to authenticate the acquired authentication information and performs the image processing.

The above and further objects and features of the invention will more fully be apparent from the following detailed description with accompanying drawings.

### BRIEF DESCRIPTION OF THE SEVERAL VIEWS OF THE DRAWINGS

FIG. 1 is a block diagram illustrating an example of a configuration of an authentication print system according to a first embodiment of the present invention;

FIG. 2 is a block diagram illustrating a configuration of a principal part of a distribution server;

FIG. 3 is a block diagram illustrating a configuration of a principal part of an authentication server;

FIG. 4 is a block diagram illustrating a configuration of a principal part of an MFP;

FIG. 5 is a flowchart illustrating an outline of a processing procedure of each CPU in the authentication print system;

FIG. 6 is a flowchart illustrating processing procedures of the CPUs involved in generation and distribution of a custom installer;

FIG. 7 is an explanatory view illustrating a configuration of the custom installer;

FIG. 8 is a flowchart illustrating a processing procedure of the CPU of a client PC involved in execution of the custom installer;

FIG. 9 is an explanatory view illustrating an example of a setting screen of a device driver in the client PC;

FIG. 10 is a block diagram illustrating a configuration of a principal part of a distribution server according to a second embodiment of the present invention;

FIG. 11 is a flowchart illustrating processing procedures of the CPUs involved in generation and distribution of a custom installer;

FIG. 12 is an explanatory view illustrating a configuration of the custom installer; and

FIG. 13 is an explanatory view illustrating a configuration of print data transmitted from the client PC in which the custom installer is executed.

### DETAILED DESCRIPTION

Hereinbelow, a detailed description will be given of embodiments in which a software distribution system according to the present invention is applied to an authentication print system which performs print output on the basis of print data of an authenticated user.

### First Embodiment

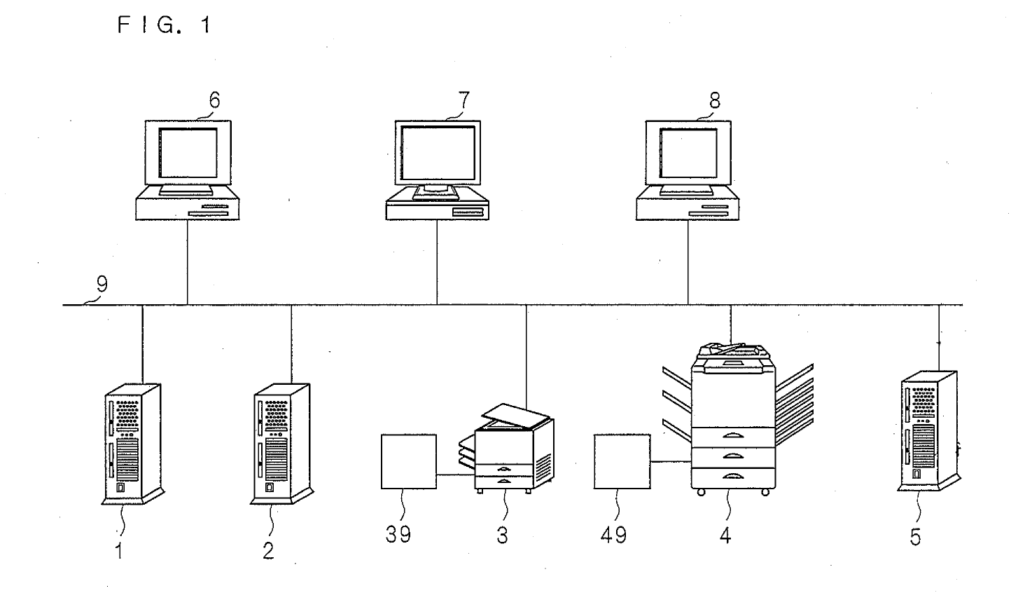

FIG. 1 is a block diagram illustrating an example of a configuration of an authentication print system according to a first embodiment of the present invention. In the drawing, a reference numeral 1 denotes a distribution server (information processing apparatus) for generating and distributing an installer, and an authentication sever (authentication apparatus) 2 for authenticating authentication information and client PCs (other information processing apparatuses) 6, 7, and 8 are connected to the distribution server 1 via a LAN 9. In addition, to the LAN 9, there are connected a print server 5 for temporarily storing print data (image data) from the client PCs 6, 7, and 8, and MFPs (Multi Function Peripheral: acquisition apparatuses, image processing apparatuses) 3 and 4 for performing print output on the basis of the print data from the print server 5. The MFPs 3 and 4 have their respective IC card readers (means for acquiring authentication information) 39 and 49 each for acquiring the authentication information.

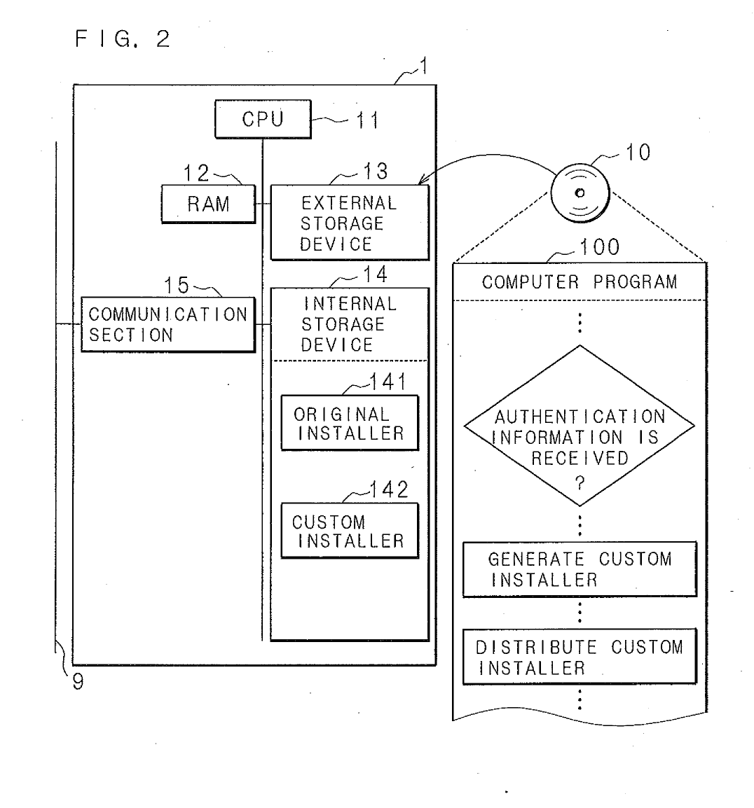

FIG. 2 is a block diagram illustrating a configuration of a principal part of the distribution server 1. The distribution server 1 includes a CPU 11 for performing processing such as an arithmetic operation or the like, and the CPU 11 is connected via a bus to a RAM 12 for storing temporary information resulting from the processing, an external storage device 13 such as a CD-ROM drive or the like, an internal storage device 14 such as a hard disk or the like, and a communication section 15 for performing communication with an external device via the LAN 9. The CPU 11 reads a computer program 100 from a recording medium 10 such as a CD-ROM or the like using the external storage device 13, and causes the internal storage device 14 to store the read computer program 100. The computer program 100 may be permanently stored in the internal storage device 14. The computer program 100 is loaded from the internal storage device 14 into the RAM 12 on an as needed basis, and the CPU 11 executes processing required by the distribution server 1 on the basis of the loaded computer program 100. The internal storage device 14 stores, as an original installer 141, an installer for a device driver for an image formation section 37 of each of the MFPs 3 and 4 which serves as a base when the distribution server 1 generates an installer (installation software). Although the generated installer is stored in the internal storage device 14 as a custom installer 142, the generated installer may also be stored in the RAM 12.

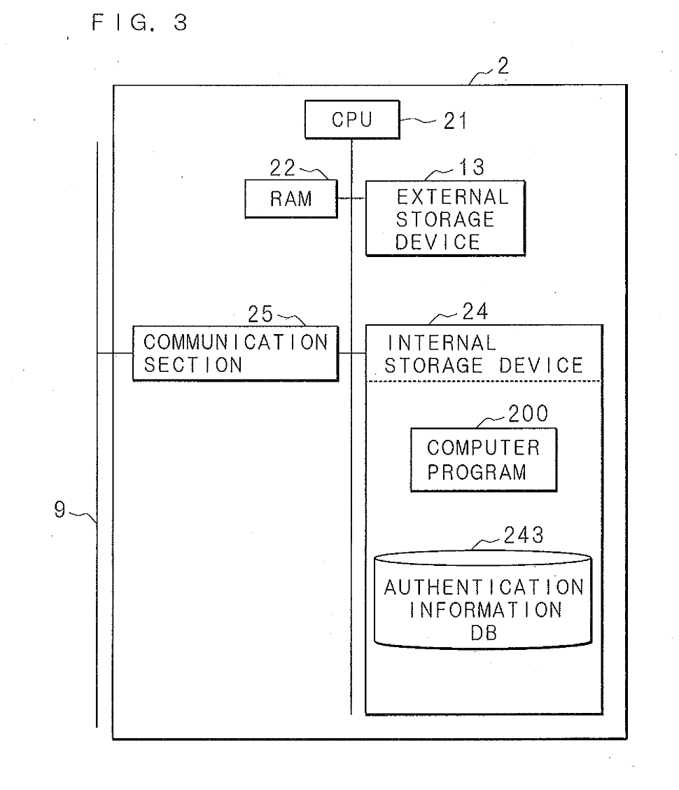

FIG. 3 is a block diagram illustrating a configuration of a principal part of the authentication server 2. The authentication server 2 includes a CPU 21 for performing processing such as an arithmetic operation or the like, and the CPU 21 is connected via a bus to a RAM 22 for storing temporary information resulting from the processing, an external storage device 23 such as a CD-ROM drive or the like, an internal storage device 24 such as a hard disk or the like, and a communication section 25 for performing communication with an external device via the LAN 9. The internal storage device 24 stores a computer program 200 to be executed by the CPU 21. The computer program 200 is loaded from the internal storage device 24 into the RAM 22 on an as needed basis, and the CPU 21 executes processing required by the authentication server 2 on the basis of the loaded computer program 200. The internal storage device 24 also stores an authentication information DB 243 for recording authentication information such as an ID, a password, and the like which are required in order to authenticate a user of the client PC 6, 7, or 8. In the present first embodiment, the authentication information is stored with an e-mail address of the user included therein. It is to be noted that an attribute of the user to be authenticated using the authentication information (for example, his or her department) may also be stored in the authentication information DB 243.

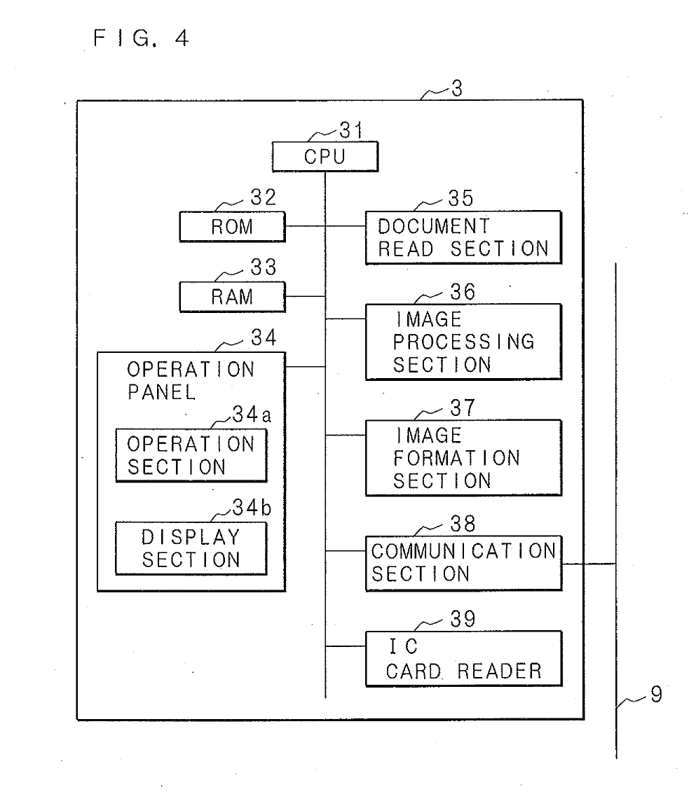

FIG. 4 is a block diagram illustrating a configuration of a principal part of the MFP 3. The principal part of the MFP 4 is the same as that of the MFP 3. The MFP 3 includes a CPU 31, and the CPU 31 is connected via a bus to a ROM 32 for storing information such as a program or the like and a RAM 33 for storing temporarily generated information. The CPU 31 executes processing such as input and output processing, an arithmetic operation, and the like in accordance with a control program pre-stored in the ROM 32. The CPU 31 is also connected via a bus to an operation panel 34 having an operation section 34a for accepting an operation of the user and a display section 34b composed of an LCD, a document read section 35 for reading a document to acquire image data, an image processing section 36 for converting the acquired image data to data suitable for print processing, an image formation section 37 for forming an image on the basis of the image data, a communication section 38 for performing communication with an external device via the LAN 9, and the IC card reader 39 for acquiring the authentication information from an IC card of the user. The communication section 38 has a modem (not shown) for performing facsimile communication with other facsimiles including the MFP 4.

In the configuration described above, in a case where print data to be printed by each of the MFPs 3 and 4 is generated by the client PCs 6, 7, and 8 each in which the device driver of the image formation section 37 of each of the MFPs 3 and 4 is installed, when the authentication information newly acquired from each of the IC card readers 39 and 49 is authenticated by the authentication server 2, each of the MFPs 3 and 4 performs print output on a paper medium on the basis of the print data to which the authenticated authentication information is added.

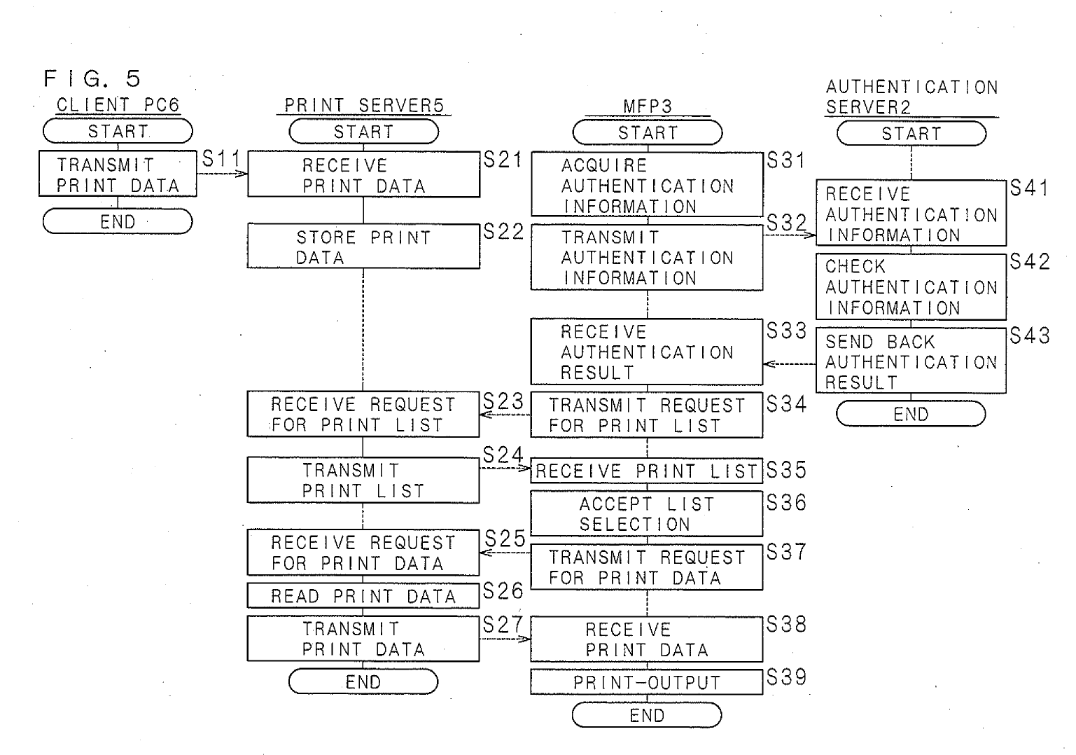

FIG. 5 is a flowchart illustrating an outline of a processing procedure of each CPU in the authentication print system. In FIG. 5, a description will be given of a case where the MFP 3 normally performs the print output on the basis of the print data generated by the client PC 6.

When the print data is generated in the client PC 6, a CPU, which is not shown, of the client PC 6 transmits the print data to which the authentication information of the user of the client PC 6 is added toward the print server 5 (S11), and terminates the processing. Thereafter, when a CPU, which is not shown, of the print server 5 receives the print data (S21), the CPU temporarily stores the received print data in a storage section which is not shown (S22).

On the other hand, when the user of the client PC 6 logs in to the system by inserting an IC card in which the authentication information of the user is recorded into the IC card reader 39 of the MFP 3, the CPU 31 of the MFP 3 acquires the authentication information from the IC card reader 39 (S31), and transmits the acquired authentication information toward the authentication server 2 through the communication section 38 (S32). The log-in mentioned above is sometimes carried out by inputting the authentication information of the user from the operation section 34a by the user.

Next, when the CPU 21 of the authentication server 2 receives the authentication information through the communication section 25 (S41), the CPU 21 checks the received authentication information against the authentication information stored in the authentication information DB 243 (S42) to perform authentication. The authentication information in this case is authentication information of a regular user, and is assumed to match with one of the authentication information items stored in the authentication information DB 243. Thereafter, the CPU 21 sends back an authentication result indicating that the authentication information items match with each other and the authentication is affirmatively performed to the MFP 3 through the communication section 25 (S43), and terminates the processing.

Subsequently, when the CPU 31 of the MFP 3 receives the authentication result sent back from the authentication server 2 through the communication section 38 (S33), and judges that the authentication information is affirmatively authenticated, the CPU 31 transmits a request for a print list of the print data including the authentication information toward the print server 5 through the communication section 38 (S34). Thereafter, when the CPU of the print server 5 receives the request for the print list transmitted from the MFP 3 (S23), the CPU generates the requested print list, and transmits the print list toward the MFP 3 (S24).

Next, when the CPU 31 of the MFP 3 receives the print list transmitted from the authentication server 2 through the communication section 38 (S35), the CPU 31 displays the received print list on the display section 34b, and accepts list selection by the user (S36). Thereafter, when the user selects the print data, the CPU 31 transmits a request for the selected print data toward the print server 5 through the communication section 38 (S37).

Subsequently, when the CPU of the print server 5 receives the request for the print data transmitted from the MFP 3 (S25), the CPU reads the requested print data from the storage section (S26), transmits the read print data toward the MFP 3 (S27), and terminates the processing. Thereafter, when the CPU 31 of the MFP 3 receives the print data transmitted from the print server 5 through the communication section 38 (S38), the CPU 31 forms an image on the basis of the received print data and print-outputs the image from the image formation section 37 (S39), and terminates the processing.

Although the example of the authentication print system is illustrated in FIG. 5, there is also a case where the print data transmitted from the client PC 6 is stored in the MFP 3, the authentication information acquired from the IC card inserted into the IC card reader 39 by the user is checked against the authentication information included in the stored print data, and the image on the basis of the print data having the matching authentication information is print-outputted. In this case, the print server 5 or the authentication server 2 is not used, and what is called a hold print (confidential print) is performed.

Hereinbelow, a description will be given of processing in which an installer in which the authentication information of the user of the client PC 6, 7, or 8 is included in an installer for a device driver of the image formation section 37 of each of the MFPs 3 and 4 is generated, and distributed to the user.

The distribution server 1 generates the custom installer 142 on the basis of the authentication information acquired from one of the IC card readers 39 and 49 and authenticated by the authentication server 2 and the original installer 141, and distributes the generated custom installer 142 to the user to be authenticated using the authentication information.

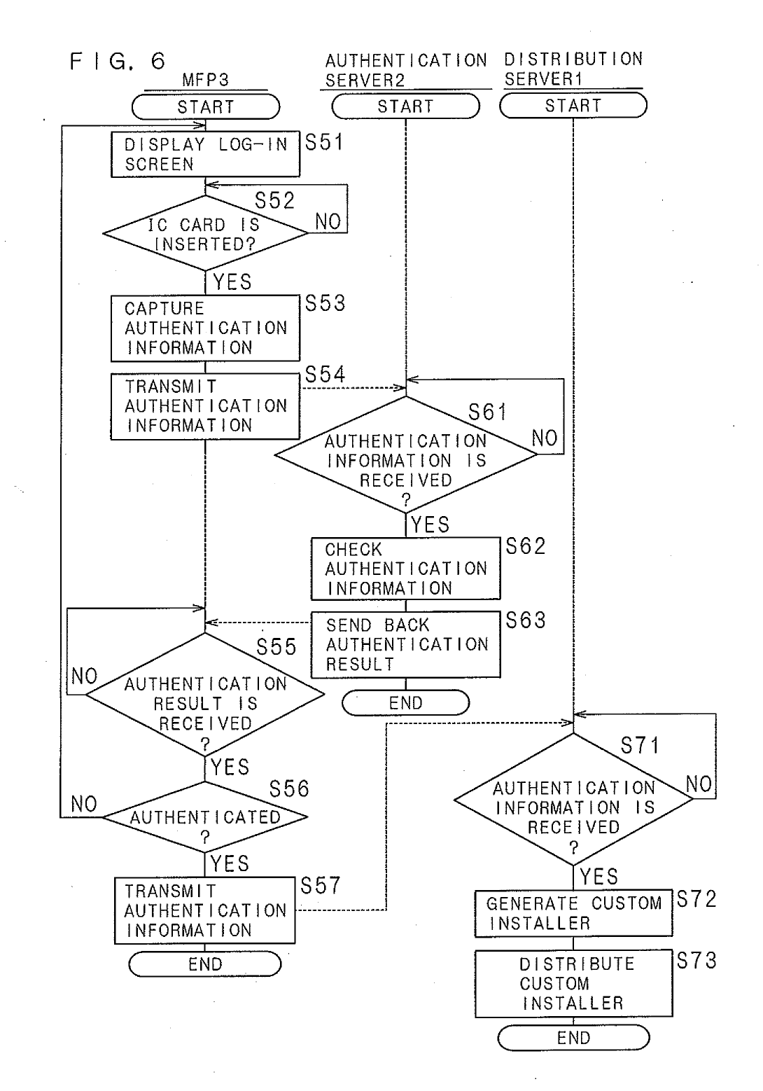

FIG. 6 is a flowchart illustrating processing procedures of the CPUs 11, 21, and 31 involved in the generation and distribution of the custom installer 142. FIG. 6 illustrates processing in a case where the user of one of the client PCs 6, 7, and 8 causes the MFP 3 to acquire the authentication information from the IC card reader 39. In the MFP 3, the user enables “a user authentication function” by using the operation section 34a, and the processing in FIG. 6 is thereby started by the CPU 31. In the authentication server 2, every time authentication of one authentication information is completed, the processing in FIG. 6 is started by the CPU 21. In the distribution server 1, every time one custom installer 142 is generated and distributed, the processing in FIG. 6 is started by the CPU 11. It is to be noted that the authentication information of the user is pre-stored in the authentication information DB 243 in the present first embodiment.

In the MFP 3, the CPU 31 displays a log-in screen on the display section 34b (S51), judges whether or not the IC card is inserted into the IC card reader 39 (S52), and stands by until the IC card is inserted (S52: NO). Thereafter, when the IC card is inserted by one user (S52: YES), the CPU 31 captures the authentication information recorded in the IC card from the IC card reader 39 (S53), and transmits the captured authentication information toward the authentication server 2 through the communication section 38 (S54).

In the authentication server 2, the CPU 21 judges whether or not the authentication information is received through the communication section 25 (S61), and stands by until the authentication information is received (S61: NO). When the authentication information is received (S61: YES), the CPU 21 checks the received authentication information against the authentication information stored in the authentication information DB 243 (S62) to perform authentication, sends back the authentication result to the MFP 3 through the communication section 25 (S63), and terminates the processing. It is to be noted that, in the present first embodiment, when the authentication information is affirmatively authenticated in the step S62, an e-mail address of the authenticated user is extracted from the authentication information DB 243, the extracted e-mail address is included in the authentication result, and the authentication result is sent back to the MFP 3 in the step S63. In this case, a configuration may also be adopted in which an attribute of the authenticated user is further extracted from the authentication information DB 243, and the extracted attribute is included in the authentication result.

Returning to the MFP 3, the CPU 31 judges whether or not the authentication result by the authentication server 2 is received (S55), and stands by until the authentication result is received (S55: NO). When the authentication result is received (S55: YES), the CPU 31 judges whether or not the authentication information is affirmatively authenticated (S56) and, when the authentication information is not authenticated (S56: NO), the CPU 31 returns the processing to the step S51. When the authentication information is authenticated (S56: YES), the CPU 31 transmits the authentication information including the e-mail address of the authenticated user toward the distribution server 1 through the communication section 38 (S57), and terminates the processing. It is to be noted that, when the attribute of the user included in the authentication result is received in the step S55, the received attribute may be transmitted together with the authentication information in the step S57.

On the other hand, in the distribution server 1, the CPU 11 judges whether or not the authentication information is received (S71), and stands by until the authentication information is received (S71: NO). When the authentication information is received (S71: YES), the CPU 11 generates the custom installer 142 such that the received authentication information is included in the original installer 141 stored in the internal storage device 14 (S72). It is to be noted that, when the attribute of the user is received together with the authentication information in the step S71, the custom installer 142 may be generated so as to further include a parameter in correspondence to the received attribute of the user in the step S72. Thereafter, the CPU 11 distributes the generated custom installer 142 to the user to be authenticated using the authentication information (S73), and terminates the processing. Specifically, by using the e-mail address of the user included in the authentication information as a recipient address, an e-mail to which the custom installer 142 is attached is transmitted through the communication section 15 toward a mail server which is not shown.

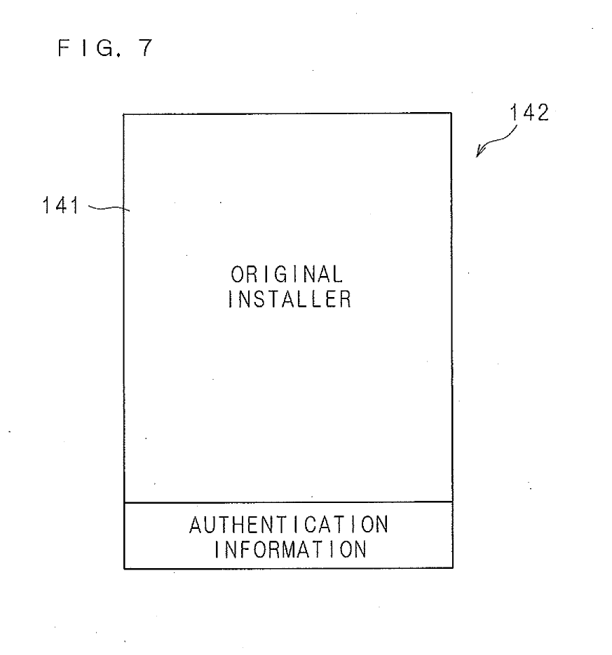

FIG. 7 is an explanatory view illustrating a configuration of the custom installer 142. The custom installer 142 is constituted as a program module including the original installer 141 and the authentication information of the user of the client PC 6, 7, or 8 in which the custom installer 142 is to be executed. The authentication information in the drawing may also be generated so as to be another program module different from the original installer 141. It is to be noted that, when the custom installer 142 including the parameter in correspondence to the attribute of the user is generated in the step S72, the parameter is added at a position rearward of the authentication information in FIG. 7.

When the custom installer 142 configured as illustrated in FIG. 7 is executed in the client PC 6, 7, or 8, the authentication is information is set as a parameter of the device driver installed by the original installer 141.

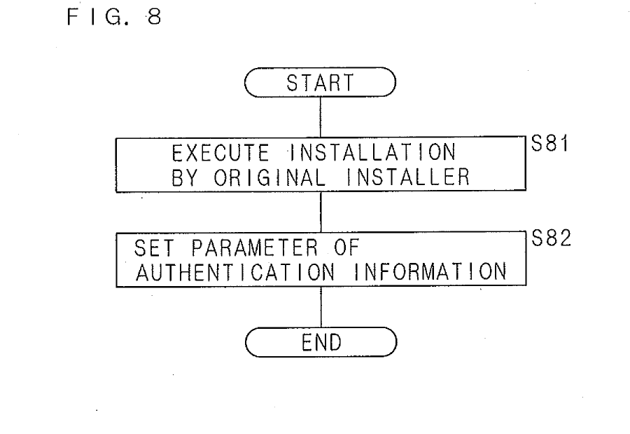

FIG. 8 is a flowchart illustrating a processing procedure of the CPU of each of the client PCs 6, 7, and 8 involved in the execution of the custom installer 142. When the custom installer 142 is executed, the CPU firstly executes the installation by the original installer 141 (S81). Specifically, the device driver of the image formation section 37 of each of the MFPs 3 and 4 is installed in each of the client PCs 6, 7, and 8. Thereafter, the CPU sets the authentication information included in the custom installer 142 as the parameter of the device driver (S82), and terminates the processing. When the parameter in correspondence to the attribute of the user is included in the custom installer 142, a parameter in correspondence to the attribute may be additionally set in the step S82.

It is to be noted that, in a case where the authentication information is generated so as to be another program module different from the original installer 141, when the original installer 141 is executed in each of the client PCs 6, 7, and 8, the authentication information included in the another program module is referred to, and set as the parameter of the device driver.

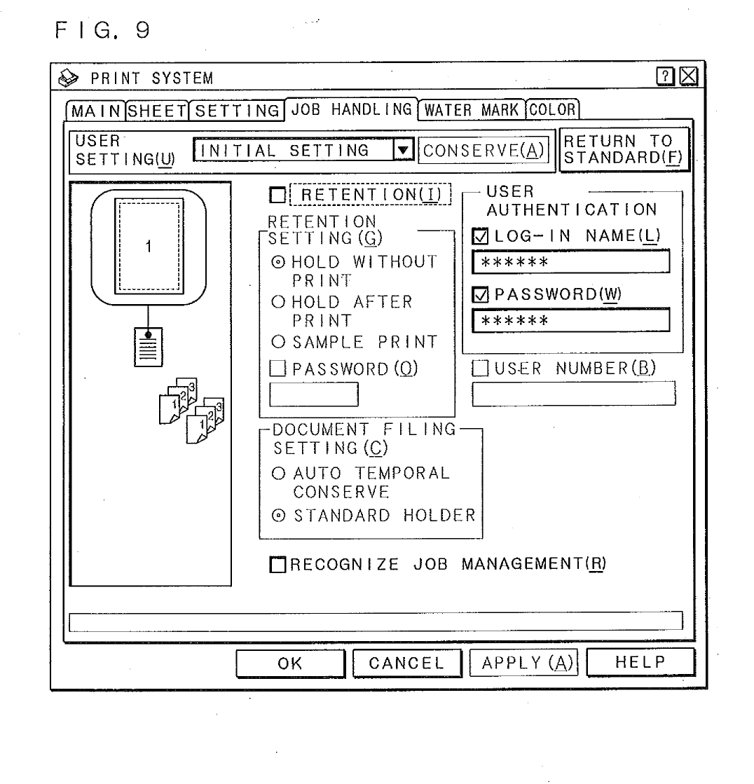

FIG. 9 is an explanatory view illustrating an example of a setting screen of the device driver in the client PC 6, 7, or 8. The setting screen is constituted to include six screens selected using tabs. Among them, when a “job handling” tab is selected, a screen for setting whether or not “user authentication” is performed and for inputting “log-in name” and “password” required when the authentication is performed is displayed. When a printer setting screen of the MFPs 3 and 4 is opened after the custom installer 142 is executed in the client PC 6, 7, or 8, the screen is displayed in a state where the authentication information (the log-in name and the password) is set, as illustrated in FIG. 9. It is to be noted that, in a case where the custom installer 142 is executed and a parameter in correspondence to the attribute of the user is set, e.g., when the parameter is a parameter which prohibits anyone from performing color printing except specific members, a display which does not allow anyone to select the color printing except the specific members is shown on a screen displayed when a “color” tab in FIG. 9 is selected.

Thus, according to the present first embodiment, the distribution server acquires the authenticated authentication information of the user to which the generated installer is to be distributed, generates the installer for the software which allows addition of the authentication information to the transmission data of the client PC and transmission of the transmission data such that the acquired authentication and the installer for the device driver of the image formation section of the MFP are included in the installer, and distributes the generated installer to the authenticated user. Consequently, the installer is distributed to the authenticated user from the distribution server with the authentication information of the user included in the installer. In addition, when the distributed installer is executed in the client PC, the authentication information of the authenticated user is added to the transmission data of the client PC.

Accordingly, it becomes possible to distribute the installer for the software to the user with the authentication information of the user or the information generated on the basis of authentication information included in the installer of the software.

Further, the installer for the device driver of the image formation section of the MFP which is to form the image on the basis of the print data from the client PC and the authentication information acquired by the distribution server are included in the installer to be distributed.

Consequently, when the installer distributed to the user is executed in the client PC, it becomes possible to install the device driver of the image formation section together with the authentication information, and add the authentication information of the user to the print data which is transmitted to the MFP by the client PC.

Furthermore, the MFP for forming the image on the basis of the print data from the client PC has the IC card reader, and also plays the role of the acquisition apparatus which acquires the authentication information of the user.

Consequently, it becomes possible to acquire the authentication information of the user to which the installer is to be distributed by the MFP which causes the authentication server to authenticate the authentication information acquired from the IC card reader and forms the image.

Although the MFPs 3 and 4 have been used as the image processing apparatus in the present first embodiment, the image processing apparatus is not limited thereto, and an apparatus for performing image analysis or image measurement may be used, or an image formation apparatus solely for forming an image (printer) may also be used as the image processing apparatus. In addition, although the authentication information of the user has been acquired from the IC card reader 39 of the MFP 3, for example, a configuration may be adopted in which a finger vein pattern is read from an infrared scanner. Further, a configuration may also be adopted in which IC card readers are directly connected to the authentication server 2 or the client PCs 6, 7, and 8, and the authentication information stored in the IC card of the user is captured by any of the IC card readers.

Moreover, although the description has been given of the example in which the authentication information is included in the generated custom installer 142 without being processed, and the example in which the authentication information is generated as another program module in the present first embodiment, the example therein is not limited thereto. For example, the custom installer 142 is generated so as to include encrypted authentication information in advance and, when the custom installer 142 is executed in the client PC 6, 7, or 8, it is possible to decrypt the encrypted authentication information and set the authentication information as the parameter of the device driver. In addition, a configuration may also be adopted in which the encrypted authentication information is set as the parameter of the device driver without being decrypted, and the encrypted authentication information included in the print data from the client PC 6, 7, or 8 is decrypted in the MFP 3.

Further, although the example in which the e-mail to which the generated custom installer 142 is attached is transmitted to the user has been described in the present first embodiment, a configuration may also be adopted in which a URL at which the custom installer 142 to be distributed is uploaded is written in the body of the e-mail addressed to the user, and the e-mail is transmitted thereto. Furthermore, a configuration may also be adopted in which the content of the custom installer 142 is written in a portable recording medium, and the portable recording medium is distributed to the user by hand.

Moreover, a configuration may be adopted in which the authentication information without the original installer 141 is generated as a program module related to setting information of the device driver, and the generated program module related to the setting information is transmitted to the user. In this case, after the original installer 141 is executed in the client PC 6, 7, or 8, the program module related to the setting information may appropriately be executed.

In addition, a configuration may also be adopted in which the custom installer 142 is transmitted toward the client PC 6, 7, or 8 which is associated with the user, and application software in the client PC 6, 7, or 8 receives and executes the custom installer 142.

Further, in the present first embodiment, as has already been described above, a configuration may also be adopted in which, when the authentication server 2 authenticates the authentication information acquired by the MFP 3, the attribute of the authenticated user is extracted from the attributes stored in the authentication information DB 243 and included in the authentication result, the MFP 3 receives the attribute of the user included in the authentication result and transmits the attribute of the user to the distribution server 1, and the distribution server 1 generates the custom installer 142 in which the parameter in correspondence to the attribute of the user received from the MFP 3 is further included.

In this case, the custom installer 142 in which the parameter in correspondence to the attribute of the authenticated user is included is attached to the e-mail addressed to the authenticated user, and the e-mail is transmitted from the distribution server 1. Subsequently, in a case where a function in correspondence to the parameter is set when the distributed custom installer 142 is executed in the client PC 6, 7, or 8, it becomes possible to permit or prohibit the use of the function in the client PC 6, 7, or 8 in accordance with the attribute of the authenticated user.

It is to be noted that a configuration may be adopted in which different original installers 141 in correspondence to the number of types of the attribute of the user are provided in the internal storage device 14 of the distribution server 1 in advance and, when the custom installer 142 is generated in the step S72 in FIG. 6, the original installer 141 in correspondence to the attribute of the user is extracted, and the custom installer 142 is generated so as to include the extracted original installer 141 and the authenticated authentication information. In this case, in the processing procedures of the CPUs of the client PCs 6, 7, and 8 involved in the execution of the custom installer 142 illustrated in FIG. 8, it becomes possible to obviate the necessity for the setting of the parameter in correspondence to the attribute of the authenticated user.

Furthermore, in a modification of the present first embodiment described above, a configuration may be adopted in which the attribute of the user is included in the authentication information acquired by the MFP 3 in advance, and the attribute of the user acquired by the MFP 3 is acquired by the distribution server 1 together with the authenticated authentication information.

In this case, it becomes possible to obviate the necessity for storing the attribute of the user in the authentication information DB 243 of the authentication server 2.

### Second Embodiment

The first embodiment has the configuration in which the distribution server 1 as an apparatus different from the authentication server 2 generates the custom installer 142 with the original installer 141 and the authentication information included in the custom installer 142. In contrast to the first embodiment, a second embodiment has a configuration in which a distribution server 1a serving also as the authentication server 2 generates a custom installer 142a with the original installer 141, the authentication information, and identification information of one of the MFPs 3 and 4 included in the custom installer 142a.

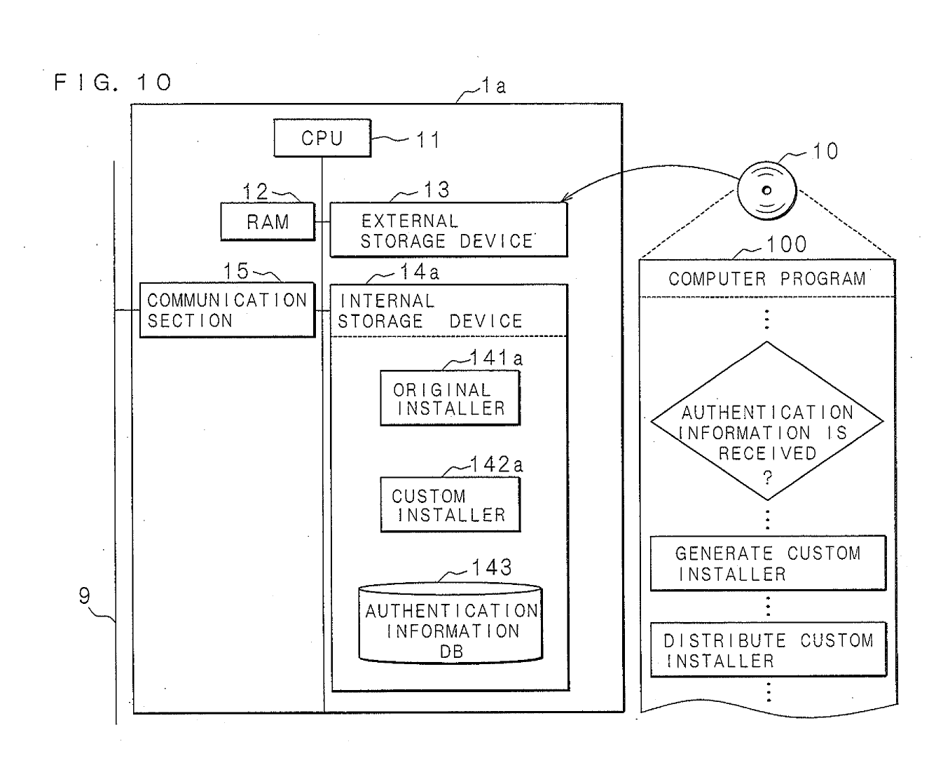

FIG. 10 is a block diagram illustrating a configuration of a principal part of the distribution server 1a according to the second embodiment of the present invention. The distribution server 1a plays roles of the distribution server 1 and the authentication server 2 in FIG. 1 in the first embodiment. The distribution server 1a includes the CPU 11 for performing processing such as an arithmetic operation or the like, and the CPU 11 is connected via a bus to the RAM 12 for storing temporary information resulting from the processing, the external storage device 13 such as a CD-ROM drive or the like, an internal storage device 14a such as a hard disk or the like, and the communication section 15 for performing communication with an external device via the LAN 9. The internal storage device 14a stores the original installer 141 and an authentication information DB 143, and stores a generated installer as the custom installer 142a.

Hereinbelow, a description will be given of processing in which there is generated an installer in which the authentication information of the user of the client PC 6, 7, or 8 and the identification information of one of the MFPs 3 and 4 are included in the installer for the device driver of the image formation section 37 of each of the MFPs 3 and 4, and the installer is distributed to the user.

The distribution server 1a checks the authentication information acquired from the IC card reader 39 (or 49) against the authentication information DB 143 to perform authentication, generates the custom installer 142a on the basis of the authenticated authentication information, the identification information of the MFP 3 (or 4), and the original installer 141, and distributes the generated custom installer 142a to the user to be authenticated using the authentication information.

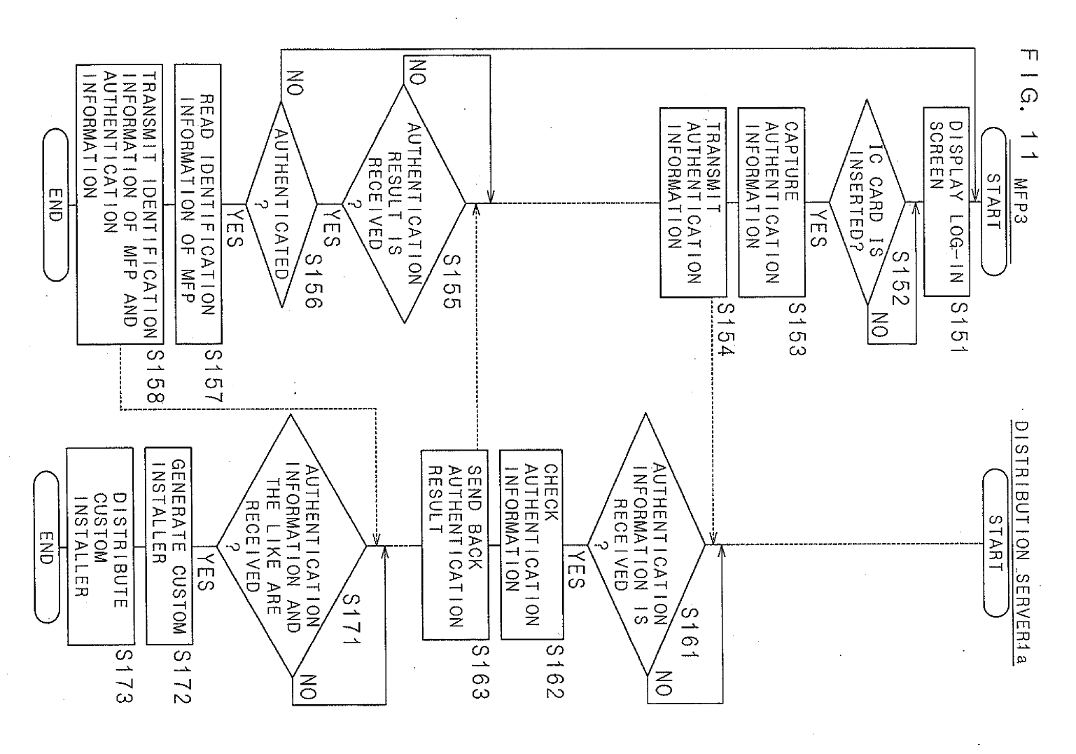

FIG. 11 is a flowchart illustrating processing procedures of the CPUs 11 and 31 involved in the generation and distribution of the custom installer 142a. FIG. 11 illustrates processing in a case where the user of one of the client PCs 6, 7, and 8 causes the MFP 3 to acquire the authentication information from the IC card reader 39. In the MFP 3, the user enables “user authentication function” by using the operation section 34a, and the processing in FIG. 11 is thereby started by the CPU 31. In the distribution server 1a, every time one custom installer 142a is generated and distributed, the processing in FIG. 11 is started by the CPU 11.

It is to be noted that a device serial number of the MFP 3 stored in the ROM 32 is used as the identification information in the present second embodiment.

Since the processing in steps S151 to S156 in the MFP 3 is the same as the processing in the steps S51 to S56 described in FIG. 6 in the first embodiment, the description thereof will be omitted.

In addition, since the processing in steps S161 to S163 executed by the CPU 11 of the distribution server 1a is the same as the processing in the steps S61 to S63 executed by the CPU 21 of the authentication server 2 described in FIG. 6 in the first embodiment, the description thereof will be omitted.

In the MFP 3, when the user having inserted the IC card into the IC card reader 39 is authenticated (S156: YES), the CPU 31 reads the identification information of the MFP 3 stored in the ROM 32 (S157), transmits the read identification information and the authentication information of the authenticated user toward the distribution server 1a through the transmission section 38 (S158), and terminates the processing.

In the distribution server 1a, after the CPU 11 terminates the processing in the step S163, the CPU 11 judges whether or not the authentication information and the like are received (S171), and stands by until the authentication information and the like are received (S171: NO). When the authentication information and the like are received (S171: YES), the CPU 11 generates the custom installer 142a such that the original installer 141 stored in the internal storage device 14a, and the received authentication information and identification information are included in the custom installer 142a (S172). Thereafter, the CPU 11 distributes the generated custom installer 142a to the user to be authenticated using the authentication information (S173), and terminates the processing.

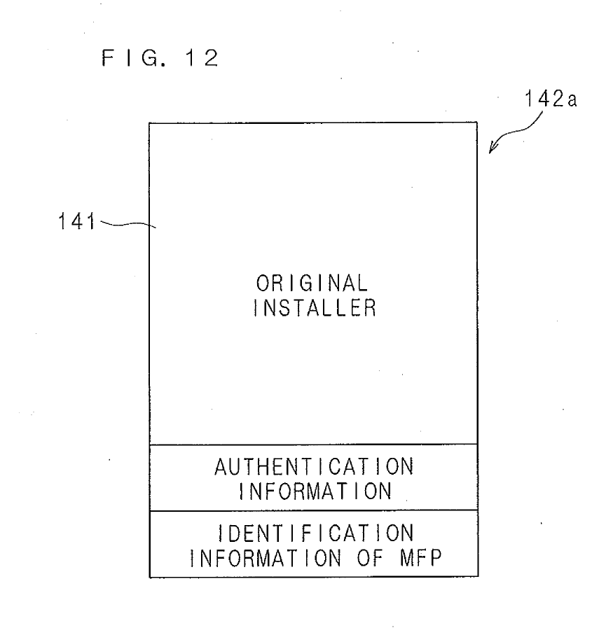

FIG. 12 is an explanatory view illustrating a configuration of the custom installer 142a. The custom installer 142a is constituted as a program module including the original installer 141, the authentication information of the user of the client PC 6, 7, or 8 in which the custom installer 142a is to be executed, and the identification information of the MFP 3 by which the authentication information of the user is acquired.

When the custom installer 142a constituted as illustrated in FIG. 12 is executed in the client PC 6, 7, or 8, the authentication information and the identification information of the MFP 3 are set as parameters of the device driver installed by the original installer 141.

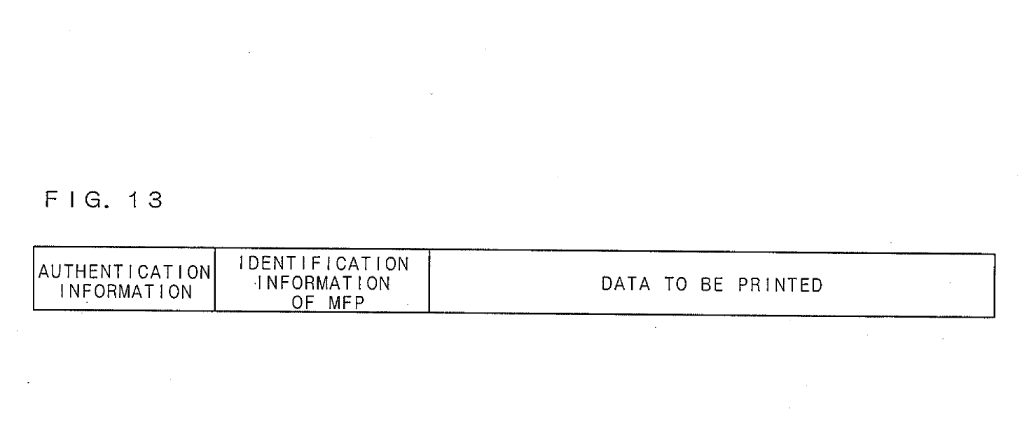

FIG. 13 is an explanatory view illustrating a configuration of print data transmitted from the client PC 6, 7, or 8 in which the custom installer has been executed. The print data illustrated in FIG. 13 includes the authentication information of the user acquired from the IC card reader 39 of the MFP 3, the identification information of the MFP 3, and data to be printed. For example, when the print data including the identification information of the MFP 3 is received by the MFP 4 via the print server 5, it is possible to have a configuration in which it is detected that the identification information items do not match with each other, and print output is not performed in the MFP 4.

Thus, according to the present second embodiment, since the distribution server also plays the role of the authentication server, it becomes possible to compactly configure the system. The same applies to a case where the authentication server is caused to serve also as the distribution server.

In addition, in a case where the print data having non-matching identification information is canceled by the MFP, the MFP which may be used by the user of the client PC as a network printer is limited to the MFP having the IC code reader with which the authentication information of the user is read when the installer is generated in the distribution server. Consequently, it becomes possible to prevent the use of the MFP which the user is not allowed to use.

It is to be noted that, in the first and second embodiments, it is possible to record the method for generating and distributing the above-described installer in another computer-readable recording medium in which a program code (executable program, intermediate code program, source program) of the computer program 100 is recorded. In this manner, it is possible to provide the recording medium in which the program for performing the method is recorded in a portable manner.

As the recording medium, a memory for execution of processing in a microcomputer not shown), e.g., a program medium such as a ROM may be used, or a program medium which becomes readable by inserting a recording medium into a program reading device, which is not shown, provided as an external storage device may also be used. In either case, a configuration may be adopted in which the stored program code is accessed and executed by the CPU 11, or a configuration may also be adopted in which the program code is read and downloaded into, e.g., a program storage area of the RAM 12, and is executed. The program for the downloading is assumed to be pre-stored in the main unit of the distribution server 1 or 1a.

The program medium is a recording medium constituted so as to be detachable from the main unit, and may also be a medium in which the program code is fixedly held including tapes such as a magnetic tape and a cassette tape; magnetic disks represented by a flexible disk and a hard disk; disks such as optical disks represented by a CD-ROM/MO/MD/DVD; cards such as an IC card (inclusive of a memory card) and an optical card, and semiconductor memories such as a mask ROM, an EPROM (Erasable Programmable Read Only Memory), an EEPROM (Electrically Erasable Programmable Read Only Memory), and a flash ROM.

The program medium may also be a medium in which the program code is held in a flowing manner such that the program code may be downloaded from a communication network including the Internet. In the case where the program code is downloaded from the communication network in this manner, the program for the downloading may be pre-stored in the main unit of the distribution server 1 or 1a, or may also be installed from other recording media. It is to be noted that the communication network is not particularly limited, and it is possible to use, e.g., the Internet, an intranet, an extranet, a LAN, an ISDN, a VAN, a CATV communication network, a virtual private network, a telephone network, a mobile communication network, a satellite communication network, and the like.

In addition, a transmission medium for constituting the communication network is not particularly limited, and it is possible to use, e.g., a wired type such as an IEEE 1394, a USB, a power-line carrier, a cable TV line, a telephone line, an ADSL line, or the like, or a wireless type such as infrared rays of IrDA and a remote controller, Bluetooth (register trademark), a 802.11 radio, an HDR, a mobile phone network, a satellite line, a terrestrial digital network, or the like. It is to be noted that the present invention may be realized in the form of a computer data signal which is realized by electronic transmission of the program code embedded in a carrier wave.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. A software distribution method for generating, using an information processing apparatus, installation software for installing software which allows addition of authentication information to transmission data and transmission of the transmission data in another information processing apparatus, and distributing the installation software to a user to be authenticated using the authentication information, comprising steps of;
acquiring the authentication information; and
generating the installation software in which the acquired authentication information or information generated on the basis of the authentication information, and predetermined software are included.

2. The software distribution method of claim 1,
wherein the predetermined software is an installer for a device driver of an image formation apparatus which is to form an image on the basis of image data transmitted by the another information processing apparatus.

3. An installation method for installing software which allows addition of authentication information to transmission data and transmission of the transmission data in an information processing apparatus by using installation software in which the authentication information or information generated on the basis of the authentication information, and predetermined software are included, comprising steps of:
causing the information processing apparatus to execute the predetermined software included in the installation software to install the software which allows the transmission of the transmission data to which the authentication information is to be added;
extracting the authentication information from the information included in the installation software; and
performing a setting of the installed software such that the extracted authentication information is added to the transmission data.

4. The installation method of claim 3,
wherein the predetermined software is an installer for a device driver of an image formation apparatus which is to form an image on the basis of image data transmitted by the information processing apparatus.

5. An information processing apparatus which distributes installation software for installing software which allows addition of authentication information to transmission data and transmission of the transmission data in another information processing apparatus to an apparatus associated with a user to be authenticated using the authentication information, comprising:
a first acquisition section acquiring the authentication information; and
a generation section generating the installation software in which the authentication information acquired by the first acquisition section or information generated on the basis of the authentication information, and predetermined software are included.

6. The information processing apparatus of claim 5,
wherein the predetermined software is an installer for a device driver of an image formation apparatus which is to form an image on the basis of image data transmitted by the another information processing apparatus.

7. A software distribution system, comprising:
the information processing apparatus of claim 5 receiving and acquiring authentication information;
an authentication apparatus receiving and authenticating the authentication information, and transmitting an authentication result to a transmission source of the authentication information; and
an acquisition apparatus acquiring the authentication information and transmitting the authentication information to the authentication apparatus, and receiving the authentication result and transmitting the authenticated authentication information to the information processing apparatus.

8. The software distribution system of claim 7,
wherein the authentication apparatus includes:
a storage section storing an attribute of a user to be authenticated using the authentication information; and
an extraction section extracting, when the authentication information acquired by the acquisition apparatus is authenticated, the attribute of the authenticated user from the attribute stored in the storage section;
wherein the attribute of the user extracted by the extraction section is included in the authentication result,
wherein the acquisition apparatus transmits the attribute of the user included in the received authentication result to the information processing apparatus,
wherein the information processing apparatus includes:
a second acquisition section acquiring an attribute of the user; and
wherein the generation section generates installation software in which information in correspondence to the attribute of the user acquired by the second acquisition section is further included.

9. The software distribution system of claim 7,
wherein the information processing apparatus is caused to serve also as the authentication apparatus.

10. The software distribution system of claim 7,
wherein the acquisition apparatus is an image processing apparatus performing image processing on an image on the basis of image data transmitted by the another information processing apparatus, and
wherein the image processing apparatus acquires the authentication information.
